(19) United States
(12) Patent Application Publication
(10) Pub. No.: US 2019/0019339 A1
(43) Pub. Date: Jan. 17, 2019

(54) SYSTEMS AND METHODS FOR DYNAMICALLY DISPLAYING INFORMATION ABOUT AN OBJECT USING AUGMENTED REALITY

(71) Applicant: Walmart Apollo, LLC, Bentonville, AR (US)

(72) Inventors: Nicholaus Adam Jones, Fayetteville, AR (US); Aaron Vasgaard, Fayetteville, AR (US); Matthew Allen Jones, Bentonville, AR (US)

(73) Assignee: Walmart Apollo, LLC, Bentonville, AR (US)

(21) Appl. No.: 16/032,843

(22) Filed: Jul. 11, 2018

Related U.S. Application Data
(60) Provisional application No. 62/531,518, filed on Jul. 12, 2017.

(51) Int. Cl. G06T 19/00; G06K 9/00; G06Q 30/02; G06F 17/30

(52) U.S. Cl. CPC G06T 19/006; G06K 9/00671; G06F 17/30991; G06F 17/30247; G06Q 30/0207

(57) ABSTRACT

Systems and methods described herein can dynamically display an augmented reality image including information about an object. The systems and methods can extract attributes from an image of, or image related to, the object and can use those attributes to construct a database query for a plurality of data sources. After querying the data sources and receiving a response, systems and methods described herein can generate data based on the response to augment the image of, or image related to, the object. The systems and methods can modify the image of, or image related to, the object based on the generated data to generate an augmented image and can display the augmented image on a display.

### RELATED APPLICATION

This application claims priority to U.S. Provisional Application No. 62/531,518, filed Jul. 12, 2017, the entire contents of which is incorporated herein by reference.

### BACKGROUND

Display of a physical object often includes only static information about the object that cannot be customized on a per user basis.

### BRIEF DESCRIPTION OF DRAWINGS

Illustrative embodiments are shown by way of example in the accompanying drawings and should not be considered as a limitation of the present disclosure:

FIG. 1 illustrates a block diagram of an augmented reality system for dynamically displaying information about an object to a user according to embodiments of the present disclosure;

FIG. 2 illustrates an exemplary use of an augmented reality system for dynamically displaying information about an object to a user according to embodiments of the present disclosure;

FIG. 3 illustrates an exemplary use of an augmented reality system for dynamically displaying information related to an object to a user according to embodiments of the present disclosure;

FIG. 4 illustrates a block diagram of an augmented reality device for dynamically displaying information about an object to a user according to embodiments of the present disclosure;

FIG. 5 illustrates an exemplary computing system for use with augmented reality systems and methods disclosed herein;

FIG. 6 illustrates a flowchart of a method for dynamically displaying an augmented reality image including information about an object according to embodiments of the present disclosure; and

FIG. 7 illustrates a block diagram of an exemplary distributed augmented reality system environment in accordance with embodiments of the present disclosure.

### DETAILED DESCRIPTION

Described in detail herein are methods, systems, and devices for dynamically displaying information about an object to a user. The methods and systems include imaging an object using an imaging device and extracting image attributes from one or more images captured by the imaging device. One or more database queries can be constructed based on the attributes and used to query data sources. Data is generated based on the response to the queries. The data generated based on the response to the queries is customized to the user of the device capturing the image(s). The methods and systems modify the image(s) of the object being rendered on a display based on the data to generate augmented image(s) that are displayed to the user.

In static, physical displays of objects, updating and maintaining accurate information about the objects is burdensome because a human must manually change the information. As a result, information about the objects such as price or other attributes can become outdated between human updates. Moreover, the information in a static display cannot be customized to the particular viewer. Such a lack of customization and slow updates disadvantage the physical manifestations of objects in comparison to digital manifestations of objects (e.g., on the Internet) for which object information can be customized for each viewer in real-time when a webpage is loaded by a web browser. Systems and methods described herein enable the provision of real-time, customized information about static, physical manifestations of objects to the user by rendering an augmented reality image that includes the image of, or image related to, the object and dynamically modifying the image to superimpose additional or different information into the image.

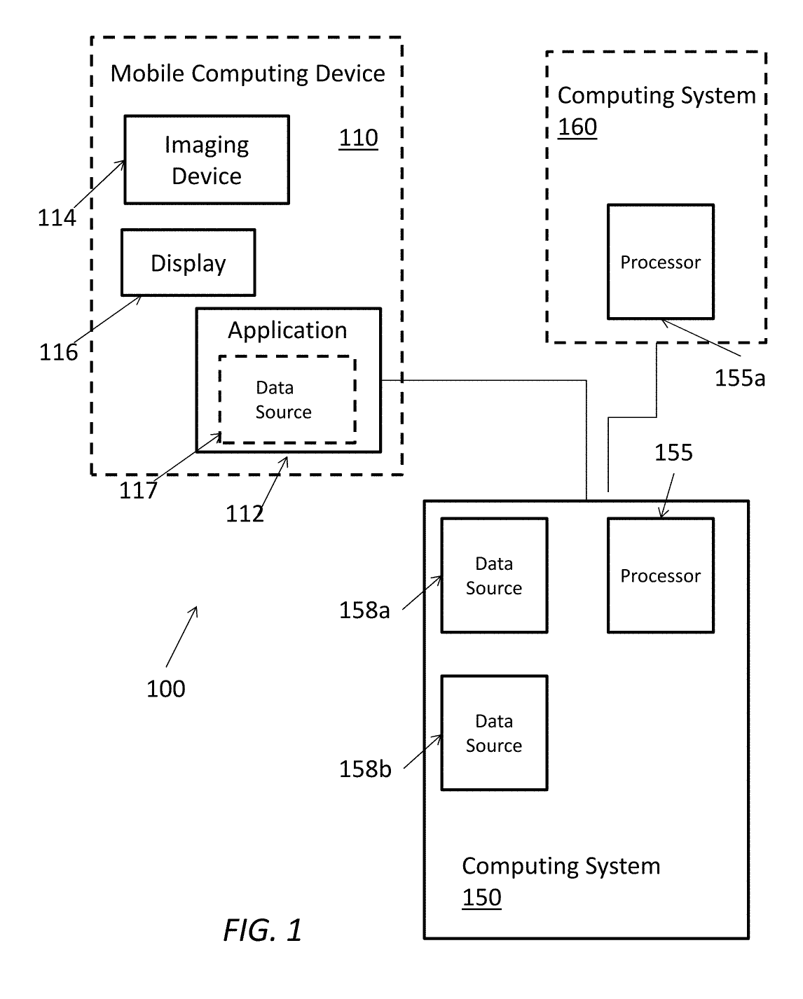

FIG. 1 illustrates a block diagram of an augmented reality (AR) system 100 for dynamically displaying information about an object to a user. The AR system 100 can include an application 112 executable on a mobile computing device 110 to process one or more images of the object captured with an imaging device 114 of the mobile computing device 110 to extract attributes of the object from the image(s). For example, the imaging device can extract alphanumeric strings or machine-readable elements from the object. The object can form a portion of a scene captured in the image(s), and the object can be identified based on parameters of pixels that form the image(s). For example, a perimeter of the object can be identified based on changes of pixel parameters at the perimeter (such as changes in pixel colors) and expected dimensions of the object. The AR system 100 can include a first computing system 150 including a processor 155 and a plurality of data sources 158a-b. The processor 155 of the first computing system 150 can receive the extracted attributes and construct one or more database queries to query the data sources 158a-b. Based on the response received (e.g., the data retrieved in response to the queries), the processor 155 can dynamically generate new data that includes information about the object customized to a user of the mobile computing device 110. The processor 155 can transmit the generated data to the application 112. The application 112 can modify the image(s) of the object based on the data to generate augmented image(s) and can render the augmented image(s) on a display 116 of the mobile computing device 110. For example, the augmented image can include information such as pricing or object attributes superimposed in, overlaid on, or otherwise embedded into the image(s) of the object.

In exemplary embodiments, in response to execution of the application 112, the imaging device 114 can be controlled to continuously capture the image(s) of a scene including the object over time (e.g., as long as the object remains in the field-of-view of the imaging device 114), and can render the image(s) of the scene including the object on the display 116 of the mobile computing device. The imaging device 114 can refresh the image(s) of the scene periodically (e.g., at a frame rate) such that a series of image(s) (e.g., that forms a moving image) are captured and the imaging device 114 identifies the object and extracts the attributes of the object based on one of the images in the series or an aggregation of the images in the series. In response to receipt of the new data generated by the processor 155, the mobile computing device can augment later captured images (i.e. images captured later in time than the images used to identify the object and extract the attributes of the object) being rendered on the display 116 to superimpose, overlay, or otherwise embed information for the object into the later captured images as the images are being captured by the imaging device 114 and rendered on the display 116 (as long as the object remains in the scene being captured by the imaging device).

In some embodiments, the application 112 can receive the image of the object from the imaging device 114. The application 112 can process the image to extract attributes of the object. For example, the application 112 can use image analytics techniques to isolate the object in the image or to detect properties of the object such as shape, size, or color. In some embodiments, the application 112 can use one or more machine vision techniques to extract attributes of the object. For example, the application 112 can use edge detection to detect object edges to determine the presence of an object, segmentation techniques to partition the image into multiple segments, pattern matching techniques that attempt to match patterns in the image with patterns corresponding to the physical object, color matching techniques that attempt to match colors in the image with a color scheme corresponding to the physical object, text recognition techniques that attempt to extract text from the image and match the extracted text to text on the physical object, and/or any other suitable machine vision techniques. Other machine vision techniques used by the application 112 to extract attributes of the object from the image can include but are not limited to: Stitching/Registration, Filtering, Thresholding, Pixel counting, Segmentation, Inpainting, Edge detection, Color Analysis, Blob discovery & manipulation, Neural net processing, Pattern recognition, Barcode Data Matrix and “2D barcode” reading, Optical character recognition and Gauging/Metrology.

In various embodiments, the extracted attributes can include the detected properties of the object. In some embodiments, the application 112 can include a data source 117 such as an object database. In some embodiments, the application 112 can compare the detected properties to object properties stored in the object database. As a result of the comparison, the object can be identified in the object database, and the attributes of the object can include information corresponding to the object in the object database. In some embodiments, the information can include, but is not limited to, an object identifier or a sale price for the object.

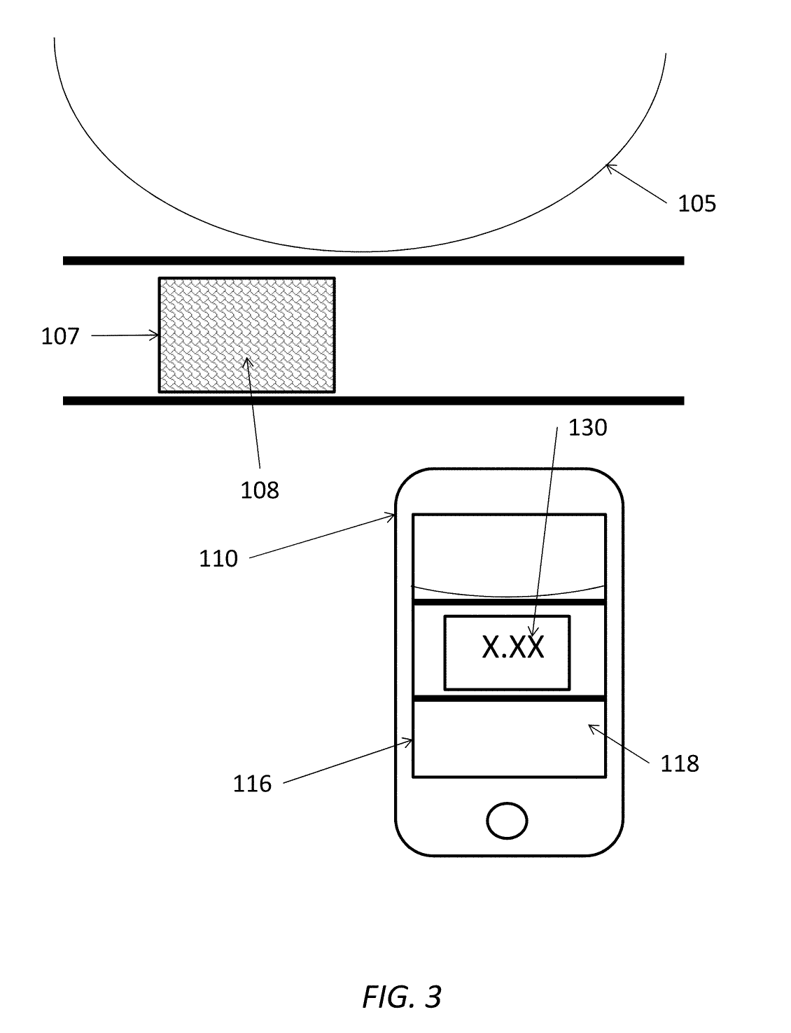

In some embodiments, the application 112 can receive an image related to the object. The image related to or representing the object may or may not include a portion of the object itself. The image can include textual or graphical information related to the object. In some embodiments, the image related to the object can include a shelf tag 107 as illustrated in FIG. 3. The shelf tag 107 can include a machine-readable pattern 108 that encodes attributes of the object. In such an embodiment, processing the image to extract attributes can include reading the machine-readable pattern 108. As non-limiting examples, the machine-readable pattern 108 could include a universal product code or a two-dimensional machine-readable barcode. In various embodiments, the application 112 can control the imaging device to obtain the image of, or image related to, the object.

The application 112 can be executed on a mobile computing device 110. In some embodiments, the mobile computing device 110 can be a smartphone, tablet, or laptop computer. The mobile computing device 110 can include the display 116. In some embodiments, the application can maintain a virtual shopping cart that includes item information representing each object that the user has placed into their shopping cart. For example, the application can provide a user interface through which the user can select an object and add the items that have been placed in their shopping cart. The item information associated with the object can be retrieved based on the attributes of the object extracted in the image(s). In some embodiments, adding and maintaining item information of objects added to the user's shopping cart can be achieved by scanning a machine-readable element as described in U.S. application Ser. No. 12/947,545, filed Nov. 16, 2010, the entire contents of which is incorporated herein by reference.

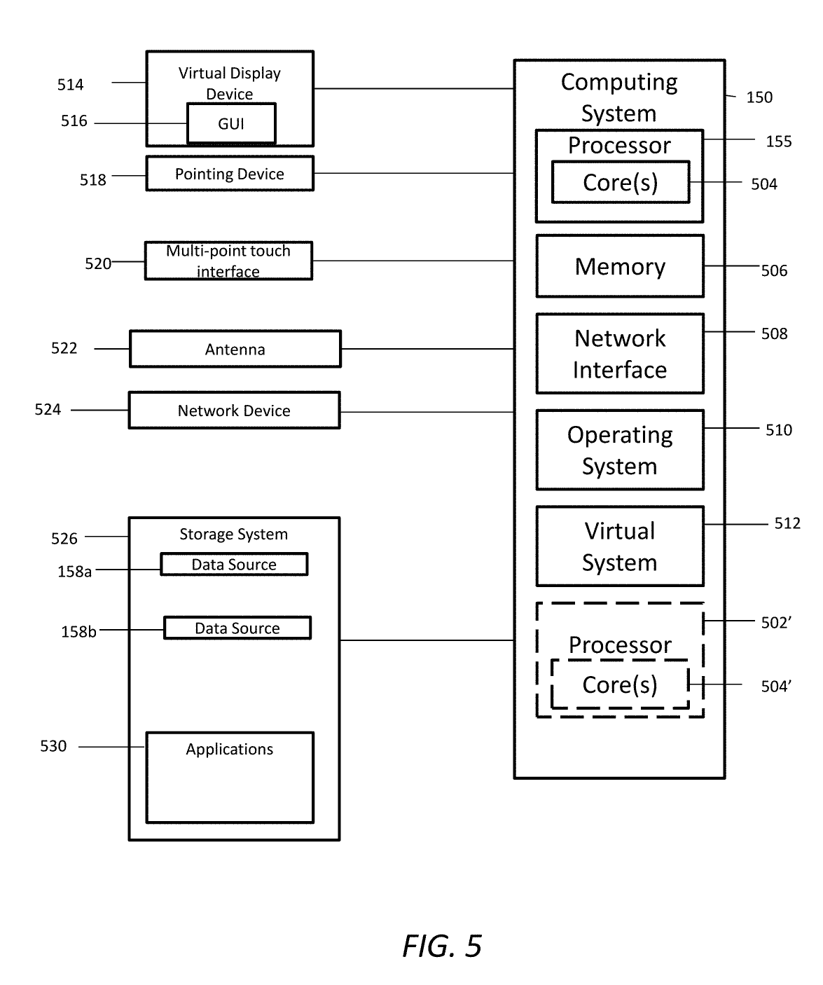

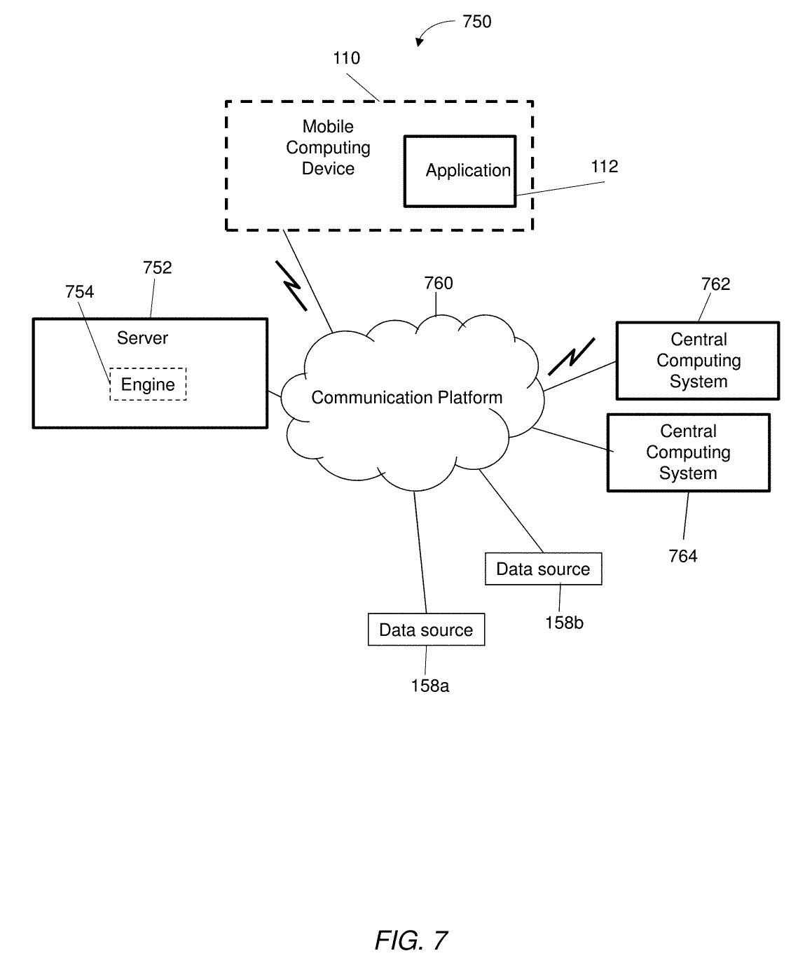

The exemplary computing system 150 is described in greater detail below with reference to FIG. 5. The processor 155 can execute instructions to receive, from the application 112, the attributes extracted from the image. For example, the application 112 and the first computing system 150 can be communicatively coupled to enable bi-directional exchange of information including image attributes and generated data as discussed in detail below. In some embodiments, the application 110 and the first computing system 150 can communicate using wireless transmissions conforming to a variety of standards including, but not limited to, BlueTooth™, Wi-Fi (e.g., various 802.11x standards), near-field communication, or any other suitable standard. The communication between the application 112 and the first computing system 150 can be direct or can be mediated through a network as described in greater detail below with reference to FIG. 7.

The processor 155 can execute instructions to construct a database query for the data sources 158a-b based on the received attributes. For example, the processor 155 can construct a database query including an object identifier derived from the received attributes that is unique to the object. In some embodiments, the received attributes can include the object identifier. In alternative embodiments, the processor 155 can execute instructions to compare the detected properties to object properties stored in the object database. As a result of the comparison, the object can be identified in the object database, and the attributes of the object can include information corresponding to the object in the object database. In some embodiments, the information can include, but is not limited to, an object identifier or a sale price for the object.

In some embodiments, the processor 155 can execute instructions to submit the query to the data sources 158a-b and to receive the response from the data sources 158a-b based on the query. In a non-limiting example, the data sources 158a-b can respond to the query with an object identifier by returning information in each database corresponding to the object identifier. If the object identifier is not found within the data sources 158a-b, the response to the query can be a nil or empty set response.

In some embodiments, the data sources 158a-b can include a database of discounted objects. In some embodiments, the database of discounted objects can include an array of object identifiers and a discount associated with each identifier. For example, the objects can include goods, the object identifiers can include a unique identifier for each good such as a universal product code, and the discount associated with each object identifier can include a rebate or price reduction offered by a manufacturer of the good. In response to the database query, the database of discounted objects can return a discount associated with the object if the object is found in the database and a nil response if the object is not found in the database.

In some embodiments, the data sources 158a-b can include a database of selected objects. In some embodiments, the database of selected objects can include an array of object identifiers corresponding to objects that the user has previously selected. For example, the objects previously selected by the user can include objects that the user has committed to purchase or has placed into a shopping cart or that are listed in a virtual shopping cart maintained by the application 112. Querying the database of selected objects can generate, in response, a binary value indicating that the object does or does not appear in the database of selected objects. In some embodiments, the processor 155 can execute instructions to place the object identifier corresponding to the object into the database of selected objects.

In some embodiments, the processor 155 can apply a discount or incentive to a purchase based upon the total contents of the database of selected objects. For example, a user may be eligible for a discount for having a large number of high-margin items in their shopping cart. In such case, the processor 155 can apply a discount to the next object that the user scans using the system 100.

In some embodiments, the processor 155 can use a video analytics module to assess what objects the user has placed into their shopping cart. For example, the video analytics module can receive video from an imaging device 114 in the mobile computing device 110 or device 200. The video analytics module can isolate areas of the video by shape or color to identify objects within the video. In some embodiments, the processor 155 can compare the visual assessment generated by the video analytics module to the contents of the database of selected objects to identify discrepancies between the contents of the database of selected objects and the user's shopping cart.

In some embodiments, the data sources 158a-b can include a database of incentivized objects. In some embodiments, the database of incentivized objects can include an array of object identifiers and an incentive associated with each product identifier. For example, the objects can include goods, the object identifiers can include a unique identifier for each good such as a universal product code, and the incentive can include a price reduction. In some embodiments, incentivized objects can be high-margin items where a price reduction is acceptable to encourage additional purchasing. In some embodiments, the incentive can be determined based on previous purchasing behavior of the user or aggregated purchasing behavior from a number of users. For example, it may be determined that purchase of the object frequently leads to purchases of additional related objects, and that a reduction in price of the object can incentivize additional purchases. In some embodiments, the incentive can be determined based upon whether the user is associated with a member category. For example, the user could be a member of a buyer rewards membership program or could be associated with a credit card account that has a membership aspect. As another example, it may be determined that a user is likely to purchase the object with an additional incentive because of the presence of units of that object or the presence of one or more related objects already placed in a user's shopping cart. In response to the database query, the database of incentivized objects can return an incentive associated with the object if the object is found in the database and a nil response if the object is not found in the database.

In some embodiments, the response from the data sources 158a-b received by the processor 155 based on the query can include individual results from the query of each data source or can include a single combined result including responses from all data source queries. For example, the result from the database of incentivized objects can depend on the result from the database of selected objects. That is, if the object already appears in the database of selected objects one or more times, an incentive may be applied to additional units of that object. Likewise, an object may be incentivized if related objects appear in the database of selected objects.

The processor 155 can execute instructions to generate data based on the response including information customized to the user of the mobile computing device. As described above, the response can include discounts or incentives that are associated with the object. In some embodiments, the processor 155 can generate data including a sale price for the object by applying the discounts or incentives to the standard retail price for the object.

In various embodiments, the data can be customized based upon the mobile computing device, the user of the mobile computing device, the season of the year, the overall number of images taken of the object in a time period, the number of images previously taken of the object by the user, or any combination thereof. In some embodiments, the data is customized to the user of the mobile computing device because the data is customized based upon objects already selected by the user (i.e., objects in the database of selected objects) or based upon objects specifically incentivized to the user. In some embodiments, the data can be customized to increase sales volume of underselling objects such as out-of-season objects or objects with low sales volume. In some embodiments, the processor 155 can execute instructions to store the generated data in one or more of the data sources 158a-b.

The processor 155 can execute instructions to transmit the generated data to the application 112. As described previously, the application 110 and the first computing system 150 can communicate using wireless transmissions conforming to a variety of standards including, but not limited to, BlueTooth™, Wi-Fi (e.g., various 802.11x standards), near-field communication, or any other suitable standard. The communication between the application 112 and the first computing system 150 can be direct or can be mediated through a network as described in greater detail below with reference to FIG. 7.

The application 112 can modify the image of, or image related to, the object based on the data to generate an augmented image. In some embodiments, the image of the object can be one of a series of images included in a video, and the augmented image can be displayed to the user as one of a series of images included in an augmented video. In some embodiments, the modification to the image of the object can include replacement of a portion of the image with the generated data. In some embodiments, the modification to the image of the object can include overlay of a portion of the image with the generated data. The application 112 can render the augmented image on the display 116 of the mobile computing device 110.

In some embodiments, the system 100 can include a second computing system 160 including a processor 155a. The processor 155a of the second computing system 160 can be configured to execute instructions to receive, from the first computing system 150, generated data corresponding to each object imaged by the user. In some embodiments, the second computing system 160 can be a point of sale device or sales register. In some embodiments, if the generated data corresponding to each object imaged by the user includes price or discount information for each object, the second computing system 160 can use the generated data to charge the correct price to the user at checkout. In accordance with various embodiments, the generated data associated with a group of objects imaged by the user is identical to generated data associated with the same group of objects imaged by a different user. For example, the prices charged for a basket of objects by the second computing system 160 can be uniform for any user checking out with that same basket of objects.

The application 112 can identify the user to the second computing system 160 to allow the first computer system 150 to access data associated with that user. In some embodiments, the application can communicate with the second computing system 160 in any of a variety of formats as described above with reference to the application 112 and the first computer system 150. In some embodiments, the application 112 can generate a machine-readable pattern on the display 116 of the mobile computing device 110 that encodes user or session information unique to the user, mobile computing device 110, or session. In such embodiments, the second computing system 160 can read the machine-readable pattern and obtain the encoded information. The encoded information can be used to retrieve data generated by the first computing system 150 for that user, mobile computing device 110, or session.

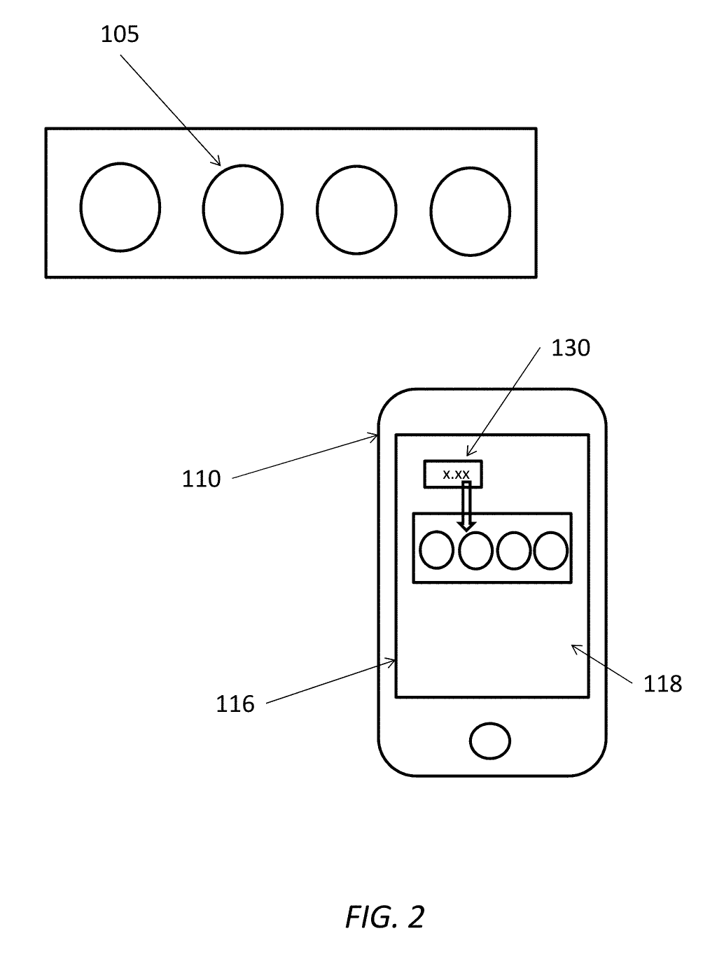

FIG. 2 illustrates an exemplary use of the augmented reality system 100 to render an augmented image of the object 105 as described above with reference to FIG. 1. The application 112 can render the augmented image 118 on the display 116 of the mobile computing device 110. As described above, the augmented image 118 can include an overlay of a portion of the image of the object 105 with the generated data 130. In some embodiments, the image of the object 105 can be modified to include additional graphical elements or features such as color, shading, shapes including arrows, or text boxes.

FIG. 3 illustrate an exemplary use of the augmented reality system 100 to render an augmented image 118 related to the object 105 as described above with reference to FIG. 1. In some embodiments, the image related to the object 105 can include the shelf tag 107 associated with the object 105. In various embodiments, the shelf tag can include plaintext or a machine-readable pattern 108 or can include one or more blank portions. In some embodiments, the machine-readable pattern can encode attributes of the object. In such embodiments, the processor-executable instruction to process the image related to the object 105 to extract attributes related to the object 105 can include reading the machine-readable pattern 108. As described above, the augmented image 118 can include replacement of a portion of the image of, or image related to, the object 105 with the generated data 130. For example, the machine-readable pattern 108 can be replaced in the augmented image with generated data 130 such as a price or other object attributes for the object 105.

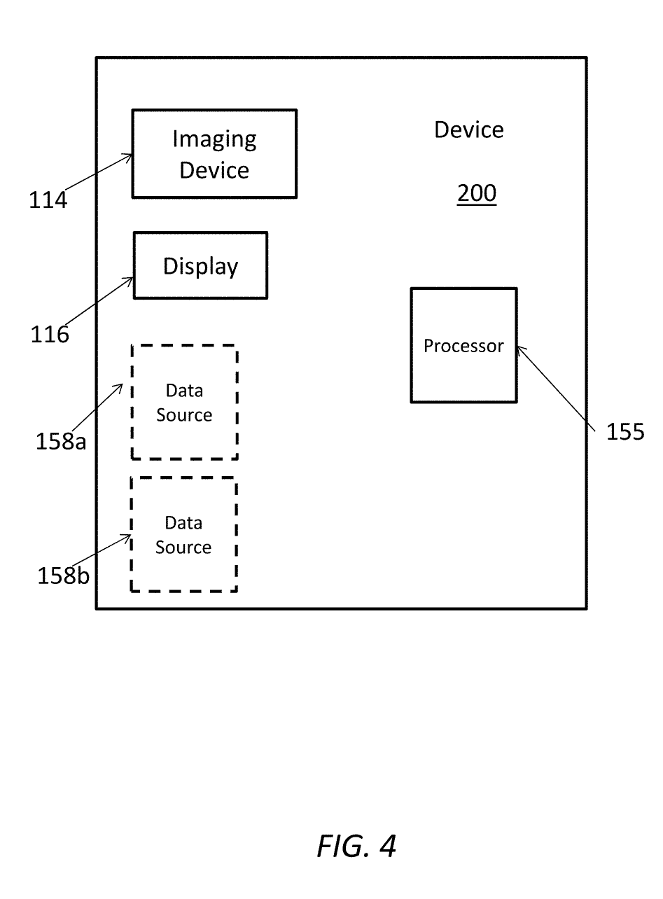

FIG. 4 illustrates a block diagram of an augmented reality device 200 for dynamically displaying information about the object to the user according to embodiments of the present disclosure. The device 200 can include the processor 155, the imaging device 114, the display 116, and the data sources 158a-b. In some embodiments, the data sources 158a-b can be provided separately, and the device 200 can access the data sources 158a-b, for example, through a network environment as described in greater detail below with reference to FIG. 7. In accordance with various embodiments, the device 200 can combine the structural and functional elements described above with reference to the application 112 and first computing system 150 in the system 100. Thus, the processor 155 of the device 200 can be configured to execute instructions to process the image of the object 105 taken with the imaging device 114 to extract attributes of the object 105 from the image. The processor 155 can execute instructions to construct a database query for the data sources 158a-b based on the attributes and can query the data sources 158a-b. The processor 155 can execute instructions to receive a response from the data sources 158a-b based on the query. The processor 155 can execute instructions to generate data based on the response to augment the image of the object 105, and the data can include information customized to the user of the device 200. The processor 155 can execute instructions to modify the image of the object 105 based on the data to generate an augmented image 118. The processor 155 can execute instructions to render the augmented image 118 on the display 116. In some embodiments, the device 200 can be provided by the facility to the user.

FIG. 5 is a block diagram of the example computing system 150 for implementing exemplary embodiments of the present disclosure. The computing system 150 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing system 150 may store computer-readable and computer-executable instructions or software (e.g., applications 530) for implementing exemplary operations of the computing system 150. The computing system 150 also includes configurable and/or programmable processor 155 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 155 and processor(s) 502′ may each be a single core processor or multiple core (504 and 504′) processor. Either or both of processor 155 and processor(s) 502′ may be configured to execute one or more of the instructions described in connection with first computing system 150.

Virtualization may be employed in the computing system 150 so that infrastructure and resources in the computing system 150 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing system 150 through a visual display device 514, such as a computer monitor, which may display one or more graphical user interfaces 516, a multi touch interface 520 or a pointing device 518.

The computing system 150 may also include one or more storage devices 526, such as a hard-drive, CD-ROM, or other computer readable media, for storing data and computer-readable instructions and/or software that implement exemplary embodiments of the present disclosure (e.g., applications). For example, exemplary storage device 526 can include the data sources 158a-b. The data sources 158a-b may be updated manually or automatically at any suitable time to add, delete, and/or update one or more data items in the databases.

The computing system 150 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing system 150 and a network and/or between the computing system 150 and mobile computing devices 110 or other computing devices. The network interface 508 may include a built-in network adapter, network interface card, PCMCIA network card, card bus network adapter, wireless network adapter, USB network adapter, modem or any other device suitable for interfacing the computing system 150 to any type of network capable of communication and performing the operations described herein.

The computing system 150 may run any operating system 510, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing system 150 and performing the operations described herein. In exemplary embodiments, the operating system 510 may be run in native mode or emulated mode. In an exemplary embodiment, the operating system 510 may be run on one or more cloud machine instances.

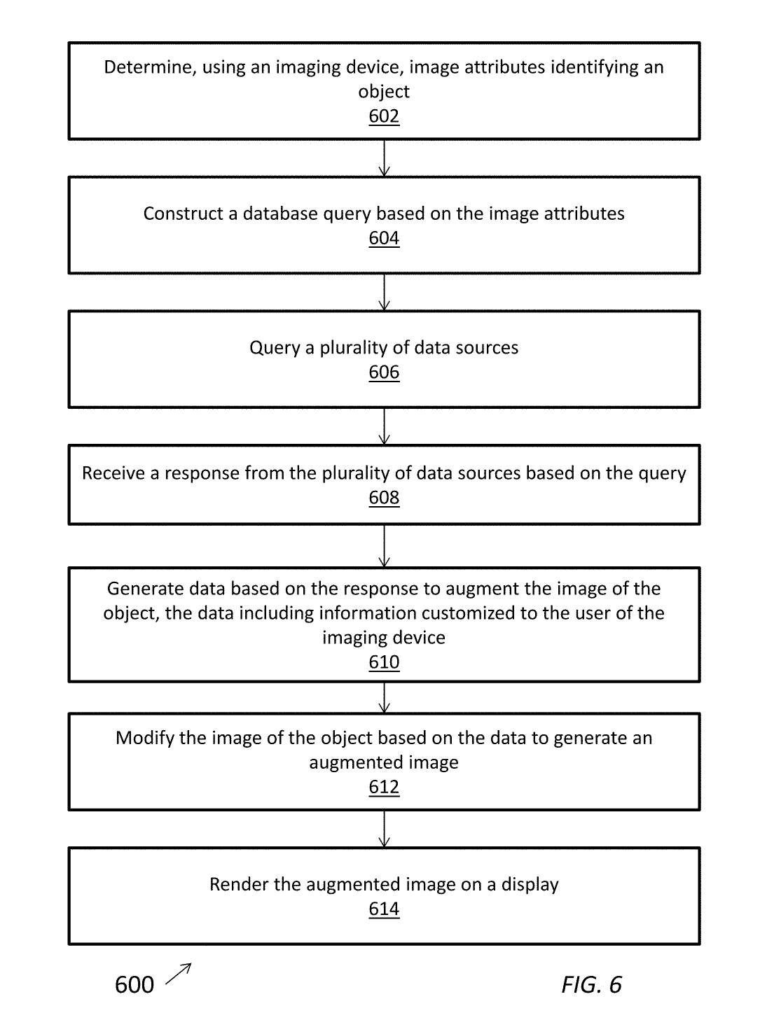

FIG. 6 illustrates an exemplary flowchart of a method 600 for dynamically displaying an augmented reality image including information about an object according to embodiments of the present disclosure. The method includes determining, using an imaging device, image attributes identifying an object (step 602). In various embodiments, the application 112 executed on the mobile imaging device 110 or the device 200 can be used to determine the image attributes as described herein. The method includes constructing a database query based on the image attributes (step 604) and querying a plurality of data sources (step 606). In some embodiments, the processor 155 of the first computing system 150 or device 200 can execute instructions to construct the query and query the data sources 158a-b as described herein.

The method includes receiving a response from the data sources based on the query (step 608). The method includes generating data based on the response to augment the image of the object (step 610). The data includes information customized to the user of the imaging device. In some embodiments, the processor 155 of the first computing system 150 or device 200 can execute instructions to generate data based on the response to augment the image of the object 105 as described above with reference to FIGS. 1 and 4. The method includes modifying the image of the object based on the data to generate an augmented image (step 612). In some embodiments, the processor 155 of the first computing system 150 or the device 200 can modify the image of the object 105 to generate an augmented image 118 as described above with reference to FIGS. 1-4. The method includes rendering the augmented image on a display (step 614). In some embodiments, the augmented image 118 can be rendered on the display 116 of the mobile computing device 110 or device 200 as described above with reference to FIGS. 1-4.

FIG. 7 is a block diagram of an exemplary distributed augmented reality system environment 750 in accordance with exemplary embodiments of the present disclosure. The environment 750 can include a server 752 configured to be in communication with the mobile computing device 110 via a communication network 760, which can be any network over which information can be transmitted between devices communicatively coupled to the network. For example, the communication network 760 can be the Internet, Intranet, virtual private network (VPN), wide area network (WAN), local area network (LAN), and the like. In some embodiments, the communication network 760 can be part of a cloud environment. The environment 750 can include one or more central computing systems 762, 764 that can be in communication with the server 752 and the mobile computing device 110 via the communication network 760. The environment 750 can include at least one repository or data source 158a-b, which can be in communication with the server 752, the mobile computing device 110, and the central computing systems 762, 764 via the communications network 760.

In exemplary embodiments, the server 752, one or more central computing systems 762, 764, and data sources 158a-b can be implemented as computing devices (e.g., first computing system 150 or second computing system 160) or mobile devices (i.e., mobile computing device 110). Those skilled in the art will recognize that the data sources 158a-b can be incorporated into the server 752 such that the server 752 can include one or more of the data sources 158a-b. In some embodiments, the data sources 158a-b can be implemented as previously described with reference to FIGS. 1 and 5. In some embodiments, the data sources 158a-b can include databases of selected objects, incentivized objects, or discounted objects, or computer-executable instructions or automated scripts that describe a technique for dynamic display of information for an object in an augmented reality image. In some embodiments, the server 752 can include one or more computational engines 754. In some embodiments, the central computing systems 762, 764 can interface with the server 752 to execute instances of the computation engine 754 to perform one or more processes described herein including, e.g., extracting object attributes from images of, or image related to, an object, constructing database queries, querying databases, receiving responses to database queries, generating data based on the received responses, modifying images of, or images related to, the object to generate an augmented image, rendering augmented images, or related functions.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components, or steps that serve the same purpose. Moreover, while exemplary embodiments have been shown and described with references to particular embodiments thereof, those of ordinary skill in the art understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art recognizes that exemplary methods may include more or fewer steps than those illustrated in the exemplary flowcharts, and that the steps in the exemplary flowcharts may be performed in a different order than the order shown in the illustrative flowcharts.

1. An augmented reality system for dynamically displaying information about an object to a user comprising:
an application executable on a mobile computing device to process an image associated with the object taken with an imaging device to extract attributes associated with the object from the image;
a first computing system communicatively coupled to a plurality of data sources and including a processor configured to execute instructions to:
receive, from the application, the attributes;
construct a database query for the plurality of data sources based on the attributes;
query the plurality of data sources;
receive a response from the plurality of data sources based on the query;
generate data based on the response to augment the image associated with the object, the data including information customized to a user of the mobile computing device; and
transmit the data to the application,
wherein the application modifies the image associated with the object based on the data to generate an augmented image, and
wherein the application renders the augmented image on a display of the mobile computing device.

2. The system of claim 1, wherein the instruction to generate data based on the response includes customizing the data to at least one of the mobile computing device, the user of the mobile computing device, the season of the year, the overall number of images taken associated with the object in a time period, the number of images previously taken associated with the object by the user, or any combination thereof.

3. The system of claim 1, wherein the plurality of data sources includes a database of discounted objects.

4. The system of claim 3, wherein the instruction to query the plurality of data sources includes determining whether the object appears in the database of discounted objects.

5. The system of claim 1, wherein the plurality of data sources includes a database of incentivized objects.

6. The system of claim 5, wherein the instruction to query the plurality of data sources includes determining whether the object appears in the database of incentivized objects.

7. The system of claim 1, wherein the processor of the first computing system is configured to execute further instructions to record, in one of the plurality of data sources, the data.

8. The system of claim 7, further comprising a second computing system including a processor configured to execute instructions to receive, from the first computing system, the data about each object imaged by the user.

9. The system of claim 1, wherein the application and the first computing system communicate using wireless transmission.

10. A method of dynamically displaying an augmented reality image including information about an object comprising:
determining, using an imaging device, image attributes identifying an object;
constructing a database query based on the image attributes;
querying a plurality of data sources;
receiving a response from the plurality of data sources based on the query;
generating data based on the response to augment the image associated with the object, the data including information customized to a user of the imaging device;
modifying the image associated with the object based on the data to generate an augmented image;
rendering the augmented image on a display.

11. The method of claim 10, wherein generating data based on the response includes customizing the data to at least one of the mobile computing device, the user of the mobile computing device, the season of the year, the overall number of images taken associated with the object in a time period, the number of images previously taken associated with the object by the user, or any combination thereof.

12. The method of claim 10, wherein the plurality of data sources includes a database of discounted objects.

13. The method of claim 12, wherein querying the plurality of data sources includes determining whether the object appears in the database of discounted objects.

14. The method of claim 10, wherein the plurality of data sources includes a database of incentivized objects.

15. The method of claim 14, wherein querying the plurality of data sources includes determining whether the object appears in the database of incentivized objects.

16. An augmented reality device for dynamically displaying an augmented image to a user including information about an object comprising:
a display;
an imaging device;
a plurality of data sources; and
a processor configured to execute instructions to:
process an image associated with the object taken with the imaging device to extract attributes associated with the object from the image;
construct a database query for the plurality of data sources based on the attributes;
query the plurality of data sources;
receive a response from the plurality of data sources based on the query;
generate data based on the response to augment the image associated with the object, the data including information customized to the user of the device;
modify the image associated with the object based on the data to generate an augmented image, and
render the augmented image on the display.

17. The device of claim 16, wherein the display is configurable to provide the data to a point-of-sale terminal.

18. The device of claim 16, further comprising a communications module to communicate the data to a point-of-sale terminal.
